(19) United States
(12) Patent Application Publication
(10) Pub. No.: US 2010/0174988 A1
(43) Pub. Date: Jul. 8, 2010

(54) SYSTEM AND METHOD FOR PROVIDING VIRTUAL INTERFACE

(76) Inventors: Chang Sun Moon, Gwangju (KR); Se Jin Pyo, Goyang-si (KR)

Correspondence Address: CANTOR COLBURN, LLP, 20 Church Street, 22nd Floor, Hartford, CT, 06103, US

(21) Appl. No.: 12/601,640

(22) PCT Filed: Sep. 3, 2007
(86) PCT No.: PCT/KR2007/004233

§ 371 Date: Nov. 24, 2009

(30) Foreign Application Priority Data
Jun. 26, 2007 (KR) 10-2007-0062865

(51) Int. Cl. G06F 3/14

(52) U.S. Cl. 715/719

(57) ABSTRACT

A system and a method of the present invention output a virtual interface screen to the display using independent video output channel which is not directly involved with the operating system. An embodiment for realizing the virtual interface uses an overlay function and the other uses a miniport function. In the case of using the overlay function, an overlay area in the video memory is used as the independent video output channel for displaying the virtual interface screen. In the case of using the miniport function, a part of commonly used general area in the video memory is used as the independent video output channel for displaying the virtual interface screen. The virtual interface of the present invention outputs a virtual interface screen independently of the operating system using an overlay function or a miniport function thereby providing the virtual interface screen to a display screen without assignment of screen resources from the operating system.

### TECHNICAL FIELD

The present invention relates to a user interface of a computer system, and more particularly, to a system and a method for providing a new type virtual interface for providing a user interface independent of an operating system.

### BACKGROUND ART

Recently, rapid development of hardware and software of a computer enables various applications using a computer in every field of society. For example, computers have been applied in general business, online banking, playback of multimedia, online game, data communication, etc. Processing speed of computers has been raised more and more by repeated improvement of operation frequency of a central processing unit. However, since response speed and processing speed of peripheral devices cannot be realized as fast as that of the central processing unit while fast data processing is realized by the central processing unit, it is difficult for a computer system to operate in high speed. In order to solve this problem, technical developments have been continued in a graphic processing field and thus it has become possible to realize in high speed a high quality two-dimensional or three-dimensional graphic image as well as a fast movie image. However, it have been developed a technology for enabling to process graphic data in higher speed since computer use environment requires increasingly to process more massive graphic data. A user interface of a computer system has been improved to be more convenient with development of an operating system technology and an application program technology. An operating system of a computer system has been developed from an early user interface environment based on text to a graphic user interface (GUI) which is currently generalized and based on graphic. An example thereof is Microsoft WINDOWS operating system. The GUI environment is used more effectively in a multitasking environment such as the WINDOWS operating system. This is because various application programs operated in the multitasking environment can display various application program screens such as a window and user interfaces thereof.

Meanwhile, some application programs operated in a multitasking environment may be operated sometimes in an exclusive mode in which the program possesses exclusively screen resources. Most game programs which should process massive graphic data in high speed are designed so as to be operated in the exclusive mode for high speed screen display. However, if one application program uses exclusively screen resources in an operating system providing a multitasking environment, other application program has no method of interfacing with a user through the single display screen which is possessed exclusively by the one application program because the other application program cannot be assigned the screen resources which have been already possessed exclusively. Of course, the other application program can be activated by inactivating the corresponding application program executed in the exclusive mode and thus canceling the exclusive mode, however it is impossible to provide the user interface simultaneously to both programs when the corresponding application program is executed in the exclusive mode.

### DISCLOSURE OF INVENTION

### Technical Problem

The present invention has been developed in order to solve the above and other problems associated with the conventional device, and an object of the present invention is to provide a system and a method for providing a virtual interface which is capable of providing a user interface independent of an operating system without assignment of screen resources from the operating system in a computer system.

Another object of the present invention is to provide a system and a method for providing a virtual interface which is capable of outputting a user interface through a display screen without inactivation of an application program operated with an exclusive assignment of screen resources from the operating system.

### Technical Solution

An aspect of the present invention to achieve the above object relates to a system for providing a user interface of a computer system provided with a video interface for screen display of a display. A system for providing a virtual interface includes a virtual interface processing module for providing a virtual interface through a video output channel for screen display which is independent of an operating system.

In an embodiment, the video output channel includes a general area in a video memory provided in the video interface. Herein, the virtual interface processing module includes a virtual interface screen displaying module for displaying a virtual interface screen through the overlay area using an overlay driver; and a message processing module for receiving a message according to an event occurrence and filtering a message involved with the virtual interface by setting a global hooking in the operating system of the computer system, and providing the filtered result value to the virtual interface screen displaying module.

In another embodiment, the video output channel includes a general area in a video memory provided in the video interface. Herein, the virtual interface processing module includes a virtual interface screen displaying module for displaying a virtual interface screen through the general area using a miniport driver; and a message processing module for receiving a message according to an event occurrence and filtering a message involved with the virtual interface by setting a global hooking in the operating system of the computer system, and providing the filtered result value to the virtual interface screen displaying module.

Another aspect of the present invention relates to a method for providing a user interface of a computer system provided with a video interface for screen display of a display. A method for providing a virtual interface of the present invention includes an initialization step of setting a global hooking of an operating system for outputting a virtual interface screen through a video output channel for screen display which is independent of an operating system; a step of receiving a message according to an event occurrence with top priority and filtering a message involved with the virtual interface; and a step of processing the filtered message involved with the virtual interface.

In an embodiment, the initialization step includes a step of producing an overlay and the virtual interface screen is displayed on a display device through an overlay area in a video memory.

In another embodiment, the initialization step includes a step of producing a miniport and the virtual interface screen is displayed on a display device through a general area in a video memory.

### BRIEF DESCRIPTION OF THE DRAWINGS

The above and other objects, features and advantages of the present invention will become apparent from the following description of preferred embodiments given in conjunction with the accompanying drawings, in which:

FIG. 1 is a block diagram illustrating a computer system provided with a virtual interface according to a preferable embodiment of the present invention.

FIG. 2 is a view illustrating a display screen provided with a virtual interface using an overlay function.

FIG. 3 is a block diagram for explaining an operation of a virtual interface processing module using an overlay function.

FIG. 4 is a flowchart illustrating operation steps of the virtual interface processing module using an overlay function.

FIG. 5 is a view illustrating a display screen provided with a virtual interface using a miniport function.

FIG. 6 is a block diagram for explaining an operation of a virtual interface processing module using a miniport function.

FIG. 7 is a flowchart illustrating operation steps of the virtual interface processing module using a miniport function.

### BEST MODE FOR CARRYING OUT THE INVENTION

The present invention, an operational advantage thereof and an object thereof achieved by an embodiment thereof will be sufficiently appreciated with reference to accompanying drawings illustrating preferred embodiment of the present invention and the description thereof. The embodiment of the present invention may be modified to various forms and it should not be appreciated that the embodiment to be described in below limits the scope of the present invention. The present embodiment is just for explaining the present invention more specifically to those skilled in the art. Further, known functions and constructions irrelevant to the subject matter of the present invention will not be described. Hereinafter, the embodiments of the present invention will be described in detail with reference to accompanying drawings.

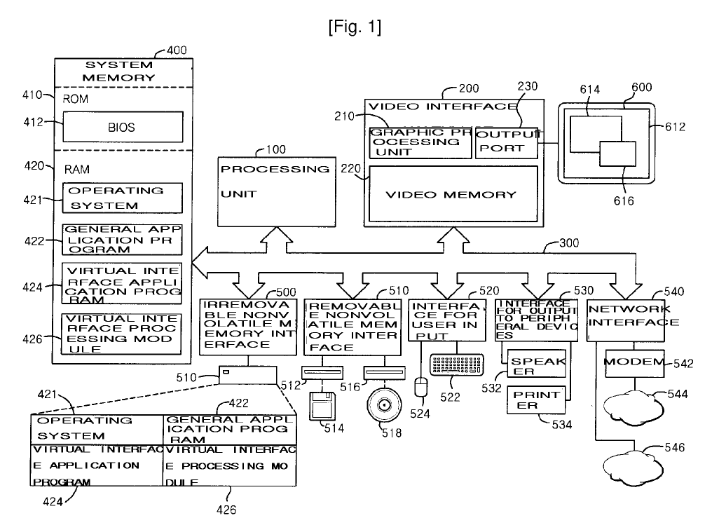

FIG. 1 is a block diagram illustrating a computer system provided with a virtual interface according to a preferable embodiment of the present invention.

Referring to FIG. 1, an exemplary computer system includes a processing unit 100, a video interface 200, a system bus 300, a system memory 400 and various kinds of interfaces 500 to 540 and peripheral devices. The various kinds of interfaces 500 to 540 are, for example, an interface 500 for an irremovable nonvolatile memory such as a hard disk device 510, an interface 510 for an removable nonvolatile memory such as a magnetic disk 514 and an optical disk 518, an interface 520 for user input such as a keyboard 522 and a pointing device 524, an interface 530 for output to the peripheral devices such as a speaker 532 and a printer 534, and a modem 542 and a network interface 540 for a modem 542 connected to a local area network 546 and for a wide area network 544.

The video interface 200 which is often referred to as a graphic card includes a graphic processing unit 210, a video memory 220 and an output port 230 connected to a display 600. The graphic processing unit 210 is in charge of an operational control of video interface 200 and calculation process of graphic data.

The hard disk 510 was stored an operating system 421, a general application program 422, a virtual interface application program 424 and a virtual interface processing module 426. The virtual interface application program 424 is an application program which is capable of providing a virtual interface through the virtual interface processing module 426 and the virtual interface processing module 426.is a processing module for providing the virtual interface and outputs the virtual interface through a display screen without an assignment of screen resources from the operating system.

The system memory 400 includes largely a ROM 410 which is a nonvolatile memory and a RAM 420 which is a volatile memory. A basic input/output system (BIOS) is mounted on the ROM 410 and the operating system 421 is loaded from the hard disk 510 to the RAM 420 to be initiated when the computer system boots up. The operating system 421 is, for example, a Microsoft WINDOWS operating system and is capable of a multitasking. At least one application program such as the general application program 422 and overlay application program 424 is loaded on the RAM when it's execution.

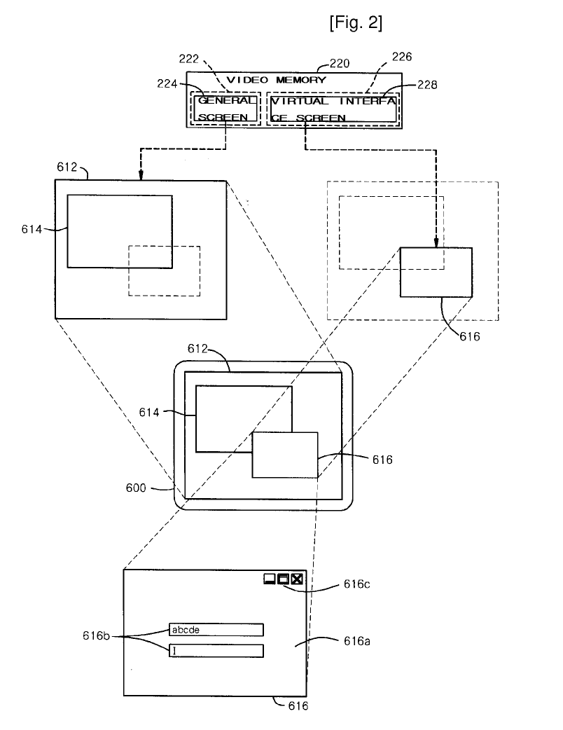

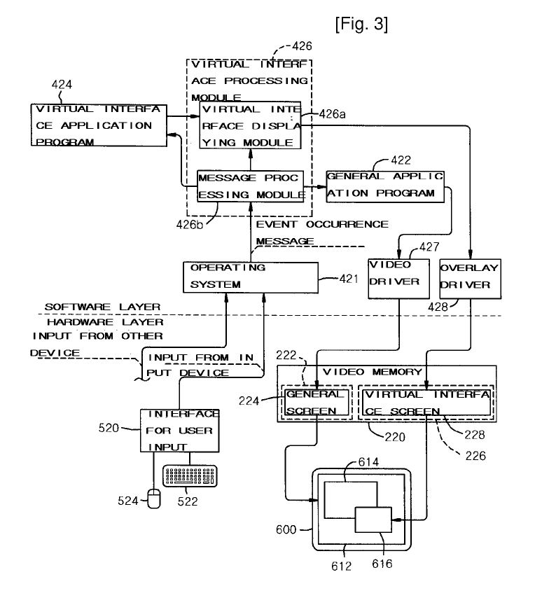

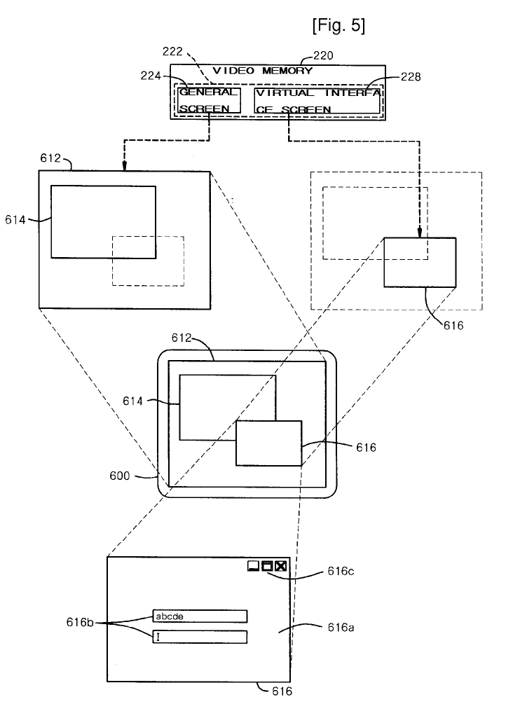

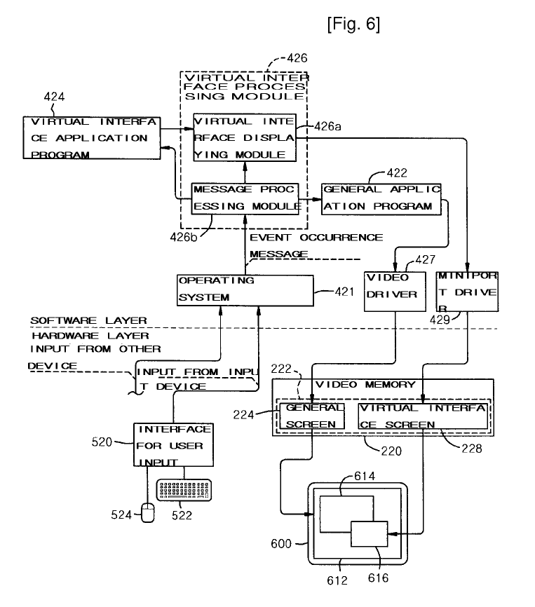

The system and method of the present invention output a virtual interface screen to the display 600 using independent video output channel which is not directly involved with the operating system 421. One embodiment for realizing the virtual interface uses an overlay function and the other uses a miniport function. In the case of using the overlay function, an overlay area 226 in the video memory 220 is used as the independent video output channel for displaying the virtual interface screen as shown in FIGS. 2 and 3. In the case of using the miniport function, a part of commonly used general area 222 in the video memory 220 is used as the independent video output channel for displaying the virtual interface screen as shown in FIGS. 5 and 6.

FIG. 2 is a view illustrating a display screen provided with a virtual interface using the overlay function.

Referring to FIG. 2, the overlay function is used in an embodiment for realizing the virtual interface of the present invention. The video memory 220 includes the general area 222 and the overlay area 226. The general area 222 is assigned for displaying screen of the operating system 421 or the general application program 422 and stores general video data 224. In the present invention, the overlay area 226 is assigned and used as an area for displaying the virtual interface screen 616 and stores overlay video data 228 for outputting the virtual interface screen.

When the overlay function is inactivated, the video interface 200 provides only general video data 224 stored in the general area 222 to the display 600 to output a background screen 612 and a general application program screen 614. When the overlay function is activated for using the virtual interface, the video interface 200 replaces a part of the video data stored in the general area 222 with the overlay video data 228 stored in the overlay area 226 and provides it to the display 600 to output the virtual interface screen 616 which is overlaid on the background screen 612 and the general application program 614. At this time, the virtual interface screen 616 is displayed on top of all other screens which are displayed.

The virtual interface provides the virtual interface screen 616 independently of the operating system 421 using the overlay area 226 in the video memory 220. In other words, the virtual interface displays the virtual interface screen 616 independently of the background screen 612 or general application program screen 614 provided by the operating system 421. The virtual interface screen 616 includes at least one screen component module such as a virtual interface background image 616a, an input box 616b for data input and a control box 616c for screen control.

FIG. 3 is a block diagram for explaining an operation of a virtual interface processing module using an overlay function.

Referring to FIG. 3, the virtual interface processing module 426 is provided for providing the virtual interface using the overlay function. The virtual interface processing module 426 is executed on the computer system together with the virtual interface application program 424. The virtual interface application program 424 may include various types of application programs. Particularly, the virtual interface application program 424 and the virtual interface processing module 426 are operated in an inactivated state in view of the operating system 421. The general application program 422 outputs the general application program screen 614 to the display 600 through a video driver 427 which controls the general area 224 of the video memory 220. On the contrary, the virtual interface application program 424 outputs the virtual interface screen 616 to the display 600 through an overlay driver 428 which controls the overlay area 226 of the video memory 220.

The virtual interface processing module 426 is in charge of a series of processing procedures by which the virtual interface screen 616 is output on the display 600. The virtual interface processing module 426 is provided with a virtual interface displaying module 426a and a message processing module 426b. The virtual interface displaying module 426a stores video data 228 which is necessary to display the virtual interface screen 616 in the overlay area 226 in the video memory 200 according to a process result of the message processing module 426b and an operation of the virtual interface application program 424. The message processing module 426b receives a message produced from occurrence of an event due to an input from the user input interface 520 or other interface devices and filters the message so that a responding process can be performed when the message is involved in the virtual interface.

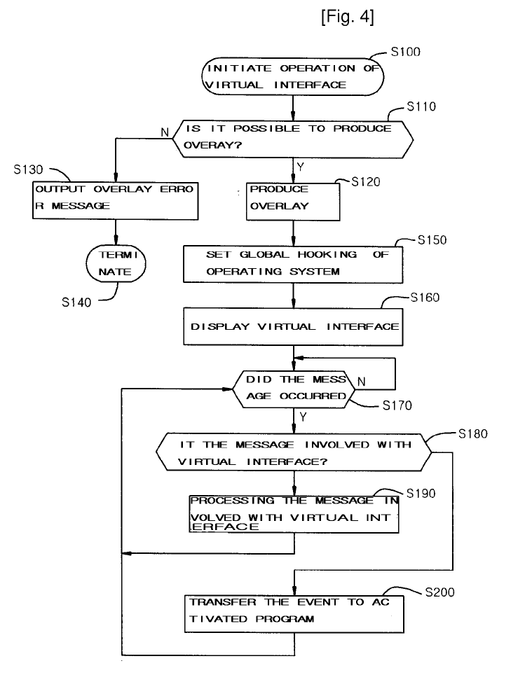

FIG. 4 is a flowchart illustrating operation steps of the virtual interface processing module using an overlay function.

Referring to FIG. 4, the virtual interface processing module 426 initiates an operation in step S100 and then whether the video interface 200 mounted on the system supports an overlay and whether usable overlay resource is remained if the overlay is supported are judged in step S110. If the production of the overlay is possible, the overlay is produced in step S120. The production of the overlay can be performed using a support library such as the DirectDraw or the DirectShow of DirectX and the OpenGL.

If the video interface 200 does not support the overlay function or there is no remained overlay resource although the video interface 200 supports the overlay function, step S130 is proceeded to output an overlay error message and the operation of the virtual interface processing module 426 is terminated in step S140.

After the production of the overlay, the virtual interface processing module 426 sets a global hooking of the operating system 421 in step S150. For example, it is possible to set the global hooking using API in a case of WINDOWS operating system. When the global hooking is set, messages related to all event occurred in the system is received with top priority by the virtual interface processing module 426. After the aforementioned initialization procedure for the virtual interface using the overlay is completed, the virtual interface screen 616 is displayed using the overlay function in step 160.

After that, the message processing module 426b determines if a message according to an event occurrence is generated in step S170. When the message is received, step S180 is proceeded to perform a filtering procedure for determining whether the received message is involved with the virtual interface. If the message is determined to be involved with the virtual interface, step S190 is proceeded to perform a process of the message involved with the virtual interface. However, it is not a message involved with the virtual interface, S200 is proceeded to send the message to the general application program 422 which is in activation.

In the step of processing the message involved with the virtual interface in the step S190, the message processing module 426b provides a message attribute value which is input as a filtered result value to the virtual interface displaying module 426a. The virtual interface displaying module 426a receives the message attribute value provided from the message processing module 426b and allows an appropriate screen to be displayed on the virtual interface screen 616. The message attribute value is also transferred to the virtual interface application program 424 to allow an essential program function of the virtual interface application program 424 to be performed. Also, the virtual interface displaying module 426a receives values to be displayed on the virtual interface screen 616 from the virtual interface application program 424 and allows an appropriate screen to be displayed on the virtual interface screen 616.

For example, when an input of the pointing device 524 occurs in an area of the virtual interface screen 616, a message according to an event involved therewith occurs and is received to the message processing module 426b. As shown in FIG. 2, when there has been an input of the pointing device 524 for selecting the input box 616b displayed on the virtual interface screen 616, the message processing module 426b notifies it to the overlay screen displaying module 426a. Then, the overlay screen displaying module 426a displays virtually a cursor for a text input at a corresponding location inside the input box 616b. In this state, when a user has input a character key through the keyboard 522, the message processing module 426b determines this to a message involved with the virtual interface and transfers the input keyboard value to the virtual interface displaying module 426a. The virtual interface displaying module 426a writes video data for displaying a character image in the overlay area 226 so that the character image according to the input keyboard value is displayed in the input box 616b. At this time, it is preferable that the video data stored in the overlay area is transformed into a YUV format which is supported by all graphic cards and then stored.

FIG. 5 is a view illustrating a display screen provided with a virtual interface using a miniport function.

Referring to FIG. 5, another embodiment for realizing the virtual interface of the present invention uses two video output channels for screen display of the display 600. The two video output channels include, for example, a general video port and a video miniport. In such manner using the two video output channels, the general area 222 in the video memory 200 is used to display the virtual interface screen 616.

FIG. 6 is a block diagram for explaining an operation of a virtual interface processing module using a miniport function.

Referring to FIG. 6, the virtual interface processing module 426 which provides a virtual interface using a miniport function is provided with, as in the aforementioned embodiment, a virtual interface displaying module 426a and a message processing module 426b. The virtual interface processing module 426 is executed on the computer system together with the virtual interface application program 424. The virtual interface application program 424 may include various types of application programs. In this embodiment, as in the aforementioned embodiment, the virtual interface application program 424 and the virtual interface processing module 426 are operated in an inactivated state in view of the operating system 421. The general application program 422 outputs the general application program screen 614 to the display 600 through a video driver 427 which controls the general area 224 of the video memory 220. On the contrary, the virtual interface application program 424 outputs the virtual interface screen 616 to the display 600 through a miniport driver 429 which controls the overlay area 226 of the video memory 220.

The virtual interface processing module 426 is in charge of a series of processing procedures by which the virtual interface screen 616 is output on the display 600. The virtual interface displaying module 426a stores video data 228 which is necessary to display the virtual interface in the general area 222 in the video memory 200 according to a process result of the message processing module 426b and an operation of the virtual interface application program 424, thereby refreshing the virtual interface screen 616. The message processing module 426b receives, as same as the aforementioned embodiment, occurrence of an event due to an input from the user input interface 520 or other interface devices and a resultant message, and filters the message so that a responding process can be performed when the message is involved in the virtual interface.

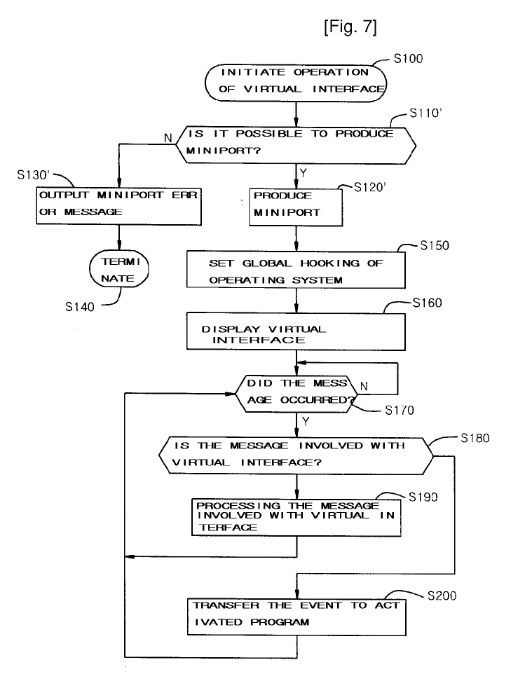

FIG. 7 is a flowchart illustrating operation steps of the virtual interface processing module using a miniport function.

Referring to FIG. 7, an operation of the virtual interface processing module 426 using the miniport has actually the same process steps as the aforementioned case using the overlay. However, it has slightly different steps in initialization procedure for the virtual interface.

Referring to FIG. 7, the virtual interface processing module 426 initiates an operation in step S100 and then whether the video interface 200 mounted on the system supports a miniport and whether usable resource is remained if the miniport is supported are judged in step S110′. If the production of the miniport is possible, the miniport is produced in step S120′. The production of the miniport can be performed using a development tool such as the WINDOWS Driver Development Kit.

If the video interface 200 does not support the miniport function or there is no remained resource for using the miniport although the video interface 200 supports the miniport function, step S130 is proceeded to output an miniport error message and the operation of the virtual interface processing module 426 is terminated in step S140.

After the production of the miniport, the virtual interface processing module 426 sets a global hooking of the operating system 421 in step S150. For example, it is possible to set the global hooking using API in a case of WINDOWS operating system. When the global hooking is set, messages related to all event occurred in the system is received with top priority by the virtual interface processing module 426. After the aforementioned initialization procedure for the virtual interface using the miniport is completed, the virtual interface screen 616 is displayed using the miniport function in step 160. After that, the process procedure according to the message occurrence is the same as the aforementioned embodiment using the overlay function.

The virtual interface of the present invention as described above can provides a user interface of inactivated application program to the display screen without inactivation of other activated application program even in a state that the other application program is activated in an operating system having a multitasking environment. Particularly, it is very useful when an application program operated in an exclusive mode as well as other one application program is executed in an inactivated state.

For example, when an online game program is activated, screen resources are possessed exclusively by the program. Therefore, in order to activate other application program, the online game program should be inactivated or terminated. In this case, by utilizing the virtual interface of the present invention, it is possible to execute the necessary application program in the inactivated state without inactivation or termination of the application program operated in the exclusive mode and to provide an interface between the application program in an inactivated state and a user through the virtual interface.

These and another features and advantages of the invention will no doubt become apparent to those skilled in the art having read the following detailed description, which makes reference to the several figures of the drawings.

### INDUSTRIAL APPLICABILITY

As described above, unlike a typical user interface which uses a general area in a video memory and is directly involved with an operating system, a virtual interface of the present invention outputs a virtual interface screen independently of the operating system using an overlay function or a miniport function, thereby providing the virtual interface screen to a display screen without assignment of screen resources from the operating system. Particularly, the virtual interface using the overlay can be used in an application program in which important information such as a password or an ID is handled and thus a security is extremely needed because the virtual interface screen cannot be monitored from the outside.

1. A system for providing a virtual interface, in a system for providing a user interface of a computer system provided with a video interface for screen display of a display, comprising:
a virtual interface processing module for providing the virtual interface through a video output channel for screen display which is independent of an operating system.

2. The system for providing a virtual interface according to claim 1, wherein the video output channel includes an overlay area in a video memory provided in the video interface.

3. The system for providing a virtual interface according to claim 2, wherein the virtual interface processing module includes:
a virtual interface screen displaying module for displaying a virtual interface screen through the overlay area using an overlay driver; and
a message processing module for receiving a message according to an event occurrence and filtering a message involved with the virtual interface by setting a global hooking in the operating system of the computer system, and providing the filtered result value to the virtual interface screen displaying module.

4. The system for providing a virtual interface according to claim 1, wherein the video output channel includes a general area in a video memory provided in the video interface.

5. The system for providing a virtual interface according to claim 4, wherein the virtual interface processing module includes:
a virtual interface screen displaying module for displaying a virtual interface screen through the general area using a miniport driver; and
a message processing module for receiving a message according to an event occurrence and filtering a message involved with the virtual interface by setting a global hooking in the operating system of the computer system, and providing the filtered result value to the virtual interface screen displaying module.

6. The system for providing a virtual interface according to claim 1, wherein a virtual interface application program using the virtual interface by the virtual interface processing module is operated in an inactivated state.

7. A method for providing a virtual interface, in a method for providing a user interface of a computer system provided with a video interface for screen display of a display, comprising:
an initialization step of setting a global hooking of an operating system for outputting a virtual interface screen through a video output channel for screen display which is independent of an operating system;
a step of receiving a message according to an event occurrence with top priority and filtering a message involved with the virtual interface; and
a step of processing the filtered message involved with the virtual interface.

8. The method for providing a virtual interface according to claim 7, wherein the initialization step includes a step of producing an overlay and the virtual interface screen is displayed on a display device through an overlay area in a video memory.

9. The method for providing a virtual interface according to claim 7, wherein the initialization step includes a step of producing a miniport and the virtual interface screen is displayed on a display device through a general area in a video memory.
